(19) United States
(12) Patent Application Publication
(10) Pub. No.: US 2026/0210899 A1
(43) Pub. Date: Jul. 23, 2026

(54) METHOD OF FABRICATION, DEVICE, AND METHOD FOR DETECTING BIOMARKERS

(71) Applicant: SIMON FRASER UNIVERSITY, Burnaby (CA)

(72) Inventors: Michael M. ADACHI, New Westminster (CA); Thushani DE SILVA, Surrey (CA); Mirette FAWZY, Vancouver (CA); Karen L. KAVANAGH, Vancouver (CA); Miriam P. ROSIN, Port Moody (CA); Amin ABNAVI, Vancouver (CA); Ribwar AHMADI, Vancouver (CA)

(21) Appl. No.: 19/138,020

(22) PCT Filed: Dec. 14, 2023
(86) PCT No.: PCT/CA2023/051664

§ 371 Date: Jun. 11, 2025

Related U.S. Application Data
(60) Provisional application No. 63/432,972, filed on Dec. 15, 2022.

(51) Int. Cl. G01N 27/327

(52) U.S. Cl. CPC G01N 27/3278; G01N 27/3276

(57) ABSTRACT

A device for detecting a biomarker concentration includes a diode comprising a semiconductor having an asymmetric geometry, the diode including a first electrode and a second electrode contacting the semiconductor on a substrate. The device also includes a functionalization layer on the surface of the semiconductor, the functionalization layer comprising biomarker specific bioreceptors.

### FIELD OF TECHNOLOGY

The present disclosure relates to the detection of biomarkers, such as cytokines, proteins, RNA, or DNA in a liquid sample.

### BACKGROUND

The elevation of biomarker levels in body fluids has been associated with numerous health conditions. The detection of these biomarkers at very low concentrations may help clinicians diagnose diseases at an early stage.

Biomarkers such as small proteins called cytokines, play an important role in regulating the inflammatory response. Other biomarkers include proteins, DNA, antibodies. Found in biofluids such as blood, saliva, and sweat, biomarkers have gained interest for various health conditions and diseases. An abnormal change in biomarker concentration is an indicator linked to Alzheimer's disease, cancers, pulmonary tuberculosis, autoimmune, and cardiovascular disease. In addition, coronavirus 2019 (COVID-19) infection is accompanied by a release of an elevated level of pro-inflammatory cytokines such as interleukins (IL-1β and IL-6) and tumor necrosis factor-α (TNF-α), in an occurrence called a ‘cytokine storm’. Studies have suggested that cytokine inhibitors are an effective treatment for improving COVID-19 survival. Treatment of many diseases is most effective at an early stage. Thus, the ability to monitor and detect early changes in biomarker levels is of great interest to clinical diagnosis.

Serum levels of TNF-α among healthy young and adult population is typically in the range of 200 fM to 300 fM. In the case of children, the serum levels can be as low as 12 fM.

Methods for measuring specific biomarkers such as cytokines include measurement via an enzyme-linked immunosorbent assay (ELISA), which is utilized in clinical laboratories and biomedical research. Single molecular assays, an ultrasensitive ELISA method, and mass spectroscopy may be utilized to detect cytokines at concentrations in the fM range, sufficiently sensitive to monitor disease in an individual. However, these methods are time-consuming and expensive, limiting wide-spread use for diagnostic applications.

Biosensors are analytical devices that include a biorecognition element, referred to as a receptor, on a transducer, which transforms the interactions between the biorecognition element and the specific target into a measurable signal.

There are a number of different sensing mechanisms in biosensors, including optical, electrical, acoustic and electrochemical measurements. For example, Ghosh et al. reported detection of TNF-α using a quantum dot-based optical aptasensor with a limit of detection (LOD) in the pM range. [Rapid detection of tumor necrosis factor-alpha using quantum dot-based optical aptasensor. IEEE Trans Nanobioscience 17, 417-423 (2018)]. A malaria biomarker employing an antibody-aptamer plasmonic biosensor reported an LOD of 18 fM.

Improvements in detection and monitoring of early changes in biomarkers at the levels indicated above are desirable.

### SUMMARY

According to one aspect of an embodiment, there is provided a device for detecting a biomarker concentration. The device includes a diode comprising a semiconductor material having an asymmetric geometry, the diode including a first electrode and a second electrode contacting the semiconductor material on a substrate. The device also includes a functionalization layer on the surface of the diode, the functionalization layer comprising biomarker specific bioreceptors.

The first electrode and the second electrode have asymmetry in metal-semiconductor contact area between the two contacts to facilitate diode rectification behaviour.

The diode includes an insulating layer on at least a portion thereof.

A first connector may be coupled to the first electrode and a second connector may be coupled to the second electrode, for electrical connection to the first electrode and the second electrode.

A measurement circuit may be connected to the first electrode and the second electrode. The measurement circuit may be configured to measure a rectification change of the diode caused by the binding of the biomarker to the bioreceptors.

The semiconductor may be a MoS₂ crystal. The MoS₂ crystal may have a thickness between 13 nm and 60 nm.

The bioreceptors may be aptamers or antibodies. In a particular example, the bioreceptors are TNF-α specific aptamers.

The functionalization layer may include a linker molecule coupling the bioreceptor to the surface of the semiconductor. The linker molecule may be, for example, glycidoxypropyl trimethoxysilane (GOPS) activated by 1,1′-carbonyldiimidazole (CDI).

The insulator layer may have a thickness of 5 nm over the semiconductor.

The first electrode and the second electrode comprise one or more metal films.

According to another aspect of an embodiment, there is provided a method of fabricating a biosensor for detecting biomarkers. The method includes disposing a semiconductor material onto a substrate, depositing metal contacts on the semiconductor material, the metal contacts having an asymmetric interface geometry with of the semiconductor material, depositing an insulator over the semiconductor material and the metal contacts, functionalizing the insulator utilizing target biomarker specific bioreceptors.

The insulating layer may be fabricated employing Al₂O₃, SiO₂, HfO etc. via any conformally depositing technique such as atomic layer deposition technique with a thickness of at least about 50 nm. For example, the insulating layer may have a thickness of about 70 nm. Afterwards, the insulating layer over the semiconductor is removed with an etchant such as Buffered Oxide Etchant (BOE) with the aid of photolithography. Another thinner layer of at least about 3 nm, for example, about 5 nm of material that is utilized to support the functionalization of the bioreceptor over the semiconductor is deposited. This second deposition may be the same material as the insulating layer and may be also deposited via the same technique such as atomic layer deposition.

Depositing the insulator may include depositing a first insulator layer to cover the metal contacts, removing the first insulator over the semiconductor material by patterning the first insulator layer, and depositing a second insulator layer to facilitate functionalization over the semiconductor material. For example, patterning the first insulator layer may be carried out by etching. Depositing the first insulator layer and depositing the second insulator layer comprise depositing by atomic layer deposition. Depositing the second insulator layer may include depositing such that the second insulator layer is about 5 nm thick.

Functionalizing may include adding linker molecules prior to treating with bioreceptors, the linker molecules coupling the bioreceptors to the insulator on the surface of the semiconductor.

Functionalizing may include treating with a coupling agent, activating the coupling agent, and immobilizing the biomarker specific bioreceptors on the coupling agent. Optionally, treating with a coupling agent includes treating with a silane coupling agent, activating the coupling agent comprises activating with carbodiimide, and immobilizing comprises immobilizing target cytokine specific aptamers on the coupling agent.

Disposing the semiconductor material on the substrate may include exfoliating a MoS₂ flake onto a Si/SiO₂ substrate.

Depositing the metal contacts may include photolithography and thermal evaporation.

Depositing the insulator may include depositing by atomic layer deposition.

Depositing the insulator includes depositing such that the insulator has a first thickness on the metal contacts and a second thickness on the semiconductor material and wherein the first thickness is greater than the second thickness.

In one example, functionalizing the insulator includes functionalizing utilizing (glycidoxypropyl)trimethoxysilane (GOPS). Activating may include activating utilizing 1,1′-carbonyldiimidazole (CDI). Immobilizing the target cytokine specific aptamer may comprise immobilizing a DNA aptamer having a sequence /5AmMC6/TGG ATG GCG CAG TCG GCG ACA A/36-FAM/ that binds to tumor necrosis factor-α (TNF-α).

According to yet another aspect, use of a sensor for detecting a biomarker concentration is provided. The sensor includes a diode comprising a semiconductor material with an asymmetric geometry, the diode including a first electrode and a second electrode contacting the semiconductor material on a substrate, and a functionalization layer on the surface of the diode, the functionalization layer comprising biomarker specific aptamers. The sensor is configured to be exposed to a sample and is configured to be coupled to a measurement device to measure the current-voltage response of the sensor to determine the change in rectification factor. The change in rectification factor is correlatable to the biomarker concentration in the sample.

The use of an asymmetric geometry semiconductor diode-based biosensor for sensitive, and specific detection of a biomarker is provided. The asymmetric geometry of the two-dimensional semiconductor material induces diode rectification behavior which is employed in biomarker detection.

Advantageously, the diode-based biosensor provides rapid and sensitive biomarker detection. Without the need of a third electrode used in the common transistor-based biosensors, this diode sensor provides much simpler electrical measurement mechanism.

### BRIEF DESCRIPTION OF THE DRAWINGS

Embodiments of the present disclosure will now be described, by way of example only, with reference to the attached figures, in which:

FIG. 1 is a perspective view of a device for detecting a biomarker concentration, in accordance with an aspect of an embodiment;

FIG. 2 is a sectional side view of the device for detecting biomarker concentration of FIG. 1;

FIG. 3 is a flowchart illustrating a method of fabricating the biosensor for detecting biomarkers in accordance with another aspect of an embodiment;

FIG. 4A through FIG. 4D show atomic force microscopy (AFM) measurements of semiconductor thickness in a device for detecting biomarker concentration in accordance with a particular example of an embodiment;

FIG. 5A through FIG. 5D show surface potential across a semiconductor device measured using Kelvin probe force microscopy (KPFM), in accordance with a particular example of an embodiment;

FIG. 6A through FIG. 6F show current-voltage curves for three asymmetric devices in accordance with examples of an embodiment and three symmetric devices;

FIG. 7A and FIG. 7B illustrate a device for detecting biomarker concentration in accordance with a particular example and a current-voltage measurement showing rectification behaviour, respectively, in accordance with a particular example of an embodiment;

FIG. 8A through FIG. 8F illustrate fabrication processes in a method of fabricating a biosensor in accordance with a particular example of an embodiment;

FIG. 9A through FIG. 9D illustrate a sectional view of a device for detecting biomarker concentration in accordance with a particular example of an embodiment, subprocesses of functionalization of the device, current-voltage curves of the device at different stages of functionalization, and fluorescence measurement illustrating successful coupling of aptamers on a sensor surface, in accordance with examples of an embodiment;

FIG. 10A through FIG. 10F include an optical image of an asymmetric device for detecting biomarker concentration, a graph illustrating current-voltage response as a function of cytokine concentration (log scale), a magnified view of the current voltage curves (linear scale), a graph illustrating normalized rectification factor (RF_{N}) as a function of cytokine concentration, specificity of the sensor against two non-targeted cytokines, and a rectification factor as a function of cytokine concentration for a device with and without aptamers, in accordance with particular examples of an embodiment;

FIG. 11A through FIG. 11D illustrate folding of an aptamer bringing negatively charged biomolecules closer to a diode surface, a schematic diagram of an apparatus for determining gate voltage effect on current-voltage response of an asymmetric-geometry diode, a graph showing a drain-source current v. drain-source voltage for different applied gate voltages (V_{GS}) ranging from 0 V to −1 V with increments of −0.1 V, and a graph of rectification factor v. applied gate voltage of the gated diode, in accordance with examples of an embodiment;

FIG. 12 shows fluorescence spectrum of the aptamer functionalized surface before and after interaction with TNF-α cytokines at a concentration of 58.5 nM, in accordance with an example of an embodiment;

FIG. 13A through FIG. 13C show the current-voltage response of a cytokine sensor device in air, gate leakage current response for the drain-source current for different applied gate voltages ranging from 0 V. to −1 V, and an AFM height image on an AL₂O₃ insulator over the sensing area of the diode, in accordance with examples of an embodiment;

FIG. 14 shows a transfer curve of the functionalized biosensor illustrating hysteresis related to the scanning speed of the gate bias, which was 10 mV/sec, in accordance with an example of an embodiment; and

FIG. 15A and FIG. 15B show optical images of degraded flakes of an initial sensor during measurements in PBS and showing discoloring due to oxidation, in accordance with an example of an embodiment.

### DETAILED DESCRIPTION

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

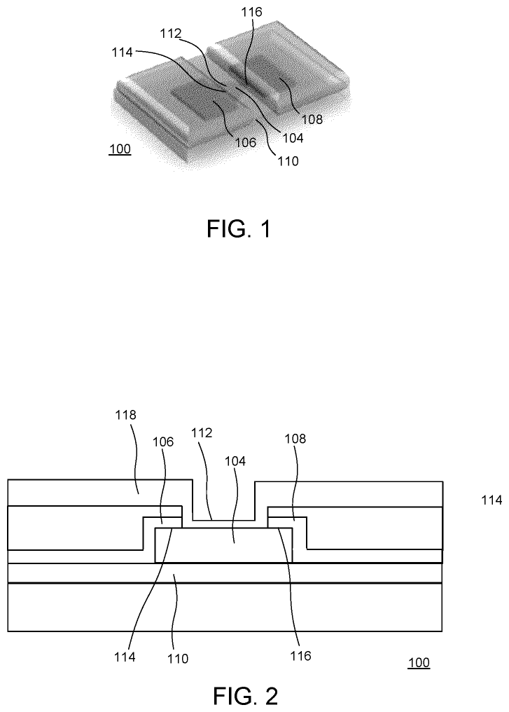

FIG. 1 and FIG. 2 show a device for detecting a biomarker concentration. The device 100 includes a diode comprising a semiconductor material 104 having an asymmetric geometry. The diode includes a first electrode 106 and a second electrode 108 contacting the semiconductor material 104 on a substrate 110. The device 100 also includes a functionalization layer 112 on the surface of the semiconductor material 104, the functionalization layer 112 comprising biomarker specific bioreceptors.

In one example, the semiconductor material 104 is MoS₂. Alternatively, the semiconductor material 104 may be silicon. In yet other alternatives, the semiconductor material may be one of GeS, WSe₂, and MoTe₂.

The semiconductor material 104 is disposed on the substrate 110, which is an insulator, such as SiO₂ disposed on a Si substrate, to electrically isolate the semiconductor material 104. Other substrate materials including other insulators may be successfully implemented.

As illustrated, the semiconductor material 104 is not symmetrical in that one side, referred to as the first side 114 of the semiconductor material 104 is larger than an opposing side, referred to as the second side 116 of the semiconductor material 104. In the example illustrated in FIG. 1, the semiconductor material is generally triangular, with the first side 114 providing the base of the triangle and the second side 116 providing a tip of the triangle. Other shapes may be successfully implemented. The semiconductor material 104 may be patterned utilizing lithography or etching or both to provide the asymmetrical geometry. Other shapes or patterns may be utilized to provide the asymmetrical geometry.

The first electrode 106 and the second electrode 108 may be similar and may include one or more layers. For example, the first electrode 106 and the second electrode 108 may each include a layer of chromium (Cr) and a layer of gold (Au). Other electrode metals may be successfully implemented. The first electrode 106 is in contact with the first side 114 of the semiconductor material 104 and the second electrode 108 is in contact with the opposing, second side 116 of the semiconductor material 104. Because the first side 114 is larger or covers a greater area than the second side 116, the first electrode 106 is in contact with a greater surface area of the semiconductor material 104 than the second electrode 108.

An insulator 118, also referred to as a passivation layer, is disposed on the surface of the semiconductor material 104 and the first electrode 106 and second electrode 108 to inhibit oxidation and aid in reducing leakage between the first electrode 106 and the second electrode 108. The insulator 118 may be thicker on the first electrode 106 and the second electrode 108 than on the semiconductor material 104. For example, the insulator 118 on the first electrode 106 may be about 75 nm while the insulator on the semiconductor material 104 may be about 5 nm.

The difference in thickness of the insulator 118 on the semiconductor material 104 versus the electrodes 106, 108 may be effected by deposition of multiple layers including one or more intermediate selective etching processes to expose the semiconductor material 104 between deposition of the layers.

The insulator may be deposited by atomic layer deposition. In one example, the insulator includes a first layer of Al₂O₃. The first layer may be selectively etched, for example, by patterning utilizing positive photoresist followed by etching utilizing a buffered oxide etch (BOE). The second layer of Al₂O₃ is then deposited.

The insulator facilitates functionalization as referred to below while electrically isolating the metal electrodes from bio fluid.

The functionalization layer 112 is disposed on the insulator 118 on the surface of the semiconductor material 104. The functionalization layer 112 is a layer of biomarker specific bioreceptors. The functionalization layer 112 may be applied by submerging in the biomarker specific bioreceptor solution. For example, the bioreceptor may be an aptamer such as a TNF-α-specific aptamer.

A first connector couples to the first electrode and a second connector couples to the second electrode. The first connector and the second connector provide electrical connection to the first electrode and the second electrode, and a measurement circuit is connected to the first electrode and the second electrode. The measurement circuit is configured to measure a rectification change of the diode caused by the binding of the biomarker to the bioreceptors.

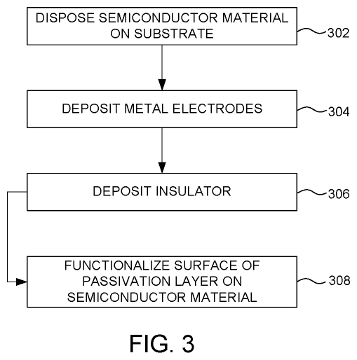

Reference is made to FIG. 3 to describe a method of fabricating a biosensor for detecting biomarkers in accordance with one aspect of an embodiment. The method may contain additional or fewer processes than shown and described and may be performed in a different order.

The semiconductor material 104 is disposed on the substrate 110 at 302. The semiconductor material 104 may be any suitable semiconductor material that acts as a diode with asymmetric geometry. As indicated above, suitable semiconductor materials include, for example, silicon, MoS₂, GeS, WSe₂, and MoTe₂. The substrate is any suitable insulator such as SiO₂ disposed on a Si stage, to electrically isolate the semiconductor material 104.

The semiconductor material 104 is disposed on the substrate 110 such that the semiconductor material 104 is asymmetrical as described above. The semiconductor material 104 may be patterned utilizing lithography or etching or both to provide the asymmetrical geometry.

The first electrode 106 and the second electrode 108 are deposited on opposing, asymmetrical sides of the semiconductor material 104 at 304 such that the first electrode 106 is in contact with a greater surface area of the semiconductor material 104 than the second electrode 108. Any suitable electrode material may be successfully implemented. For example, the electrodes 106, 108 may include a layer of chromium (Cr) and a layer of gold (Au).

At 306, the insulator 118 is deposited on the surface of the semiconductor material 104 and the first electrode 106 and second electrode 108 to inhibit oxidation and aid in reducing leakage between the first electrode 106 and the second electrode 108. The insulator 118 is deposited such that the insulator is relatively thinner on the semiconductor material 104 and the relatively thicker on the first electrode 106 and the second electrode 108.

The difference in thickness of the insulator may be accomplished depositing a first layer, for example, of Al₂O₃, of about 70 nm. The first layer is patterned, for example, by selective etching. For example, the first layer may be selectively etched by patterning utilizing positive photoresist via photolithography followed by etching utilizing a suitable etchant such as BOE. The selective etching exposes a sensing area of the semiconductor material 104 on the substrate 110. A second layer of the insulator 118 is then deposited, covering the exposed surface of the semiconductor material 104 and the remaining first layer of the insulator 118. Thus, the resulting insulator 118 is thicker on the first electrode 106 and the second electrode 108 than on the semiconductor material 104. Again, the second layer of the insulator 118 may also be deposited by atomic layer deposition.

The insulator 118 on the semiconductor material 104 is functionalized at 308 utilizing target biomarker specific bioreceptors. The insulator 118 may be functionalized by treating utilizing a coupling agent. For example, a silane coupling agent may be utilized on an Al₂O₃ insulator. The coupling agent is utilized to couple to the surface of the insulator on the semiconductor material 104. The coupling agent may be activated, for example, utilizing a 1-1′carbonyldiimidazole (CDI) linker to provide activated sites on the coupling agent, suitable to couple activated sites to a target biomarker specific bioreceptor. The target biomarker specific bioreceptor may then be immobilized on the activated sites by submerging in a biomarker specific bioreceptor solution such as a TNF-α-specific aptamer. Thus, a functional surface is provided for targeting the biomarker specific bioreceptor.

In use, the insulator 118 on the semiconductor material 104 is functionalized to configure the surface of the device 100 to be exposed to a bio sample such as blood, or other body fluid. The device 100 includes the first electrode 106 and the second electrode 108 and is thus configured to be connected to a measurement device to measure a current-voltage response of the sensor to determine the change in rectification factor in a current-voltage curve. The rectification behaviour correlates with the concentration of biomarker introduced on the functionalized surface by the bio sample. Utilizing the correlation, a biomarker concentration is determined.

### Example

A specific example of a biosensor for detecting biomarkers is provided below. In this example, the biosensor is an aptamer-based cytokine diode sensor. This example is submitted to further illustrate one aspect of an embodiment and is intended to illustrative and is not intended to limit the scope of protection.

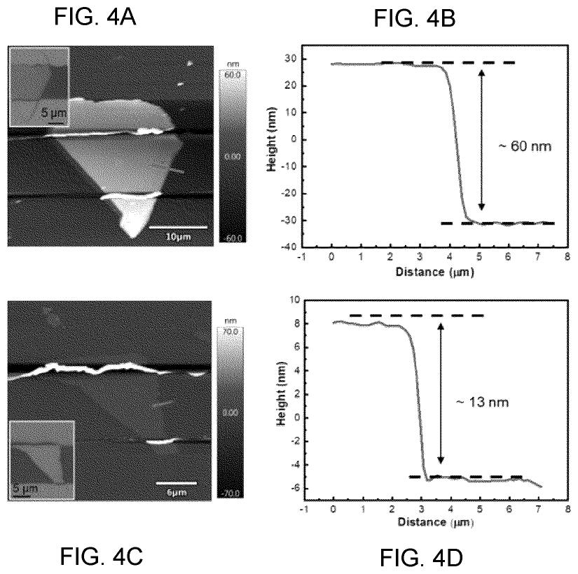

Multilayer 2H-phase semiconducting MoS₂ flakes were utilized as the semiconductor material. The flakes were mechanically exfoliated onto thermally-oxidized SiO₂ having an oxide thickness of 300 nm. Flakes were selected for device fabrication based on their shape, i.e., their geometric asymmetry, under an optical microscope. Based on atomic force microscopy (AFM) measurements, typical thicknesses were between about 13 nm and about 60 nm, as shown in FIG. 4A through FIG. 4D. Gold (Au) contacts were fabricated utilizing photolithography to form two electrical contacts across the flake, a distance of about 10 μm apart.

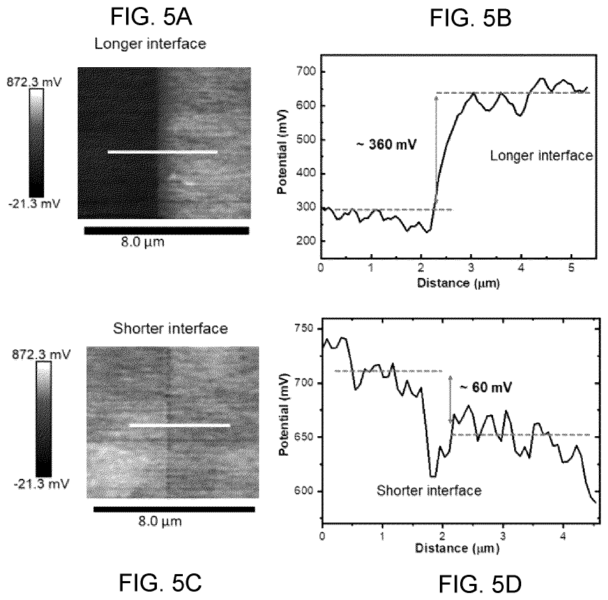

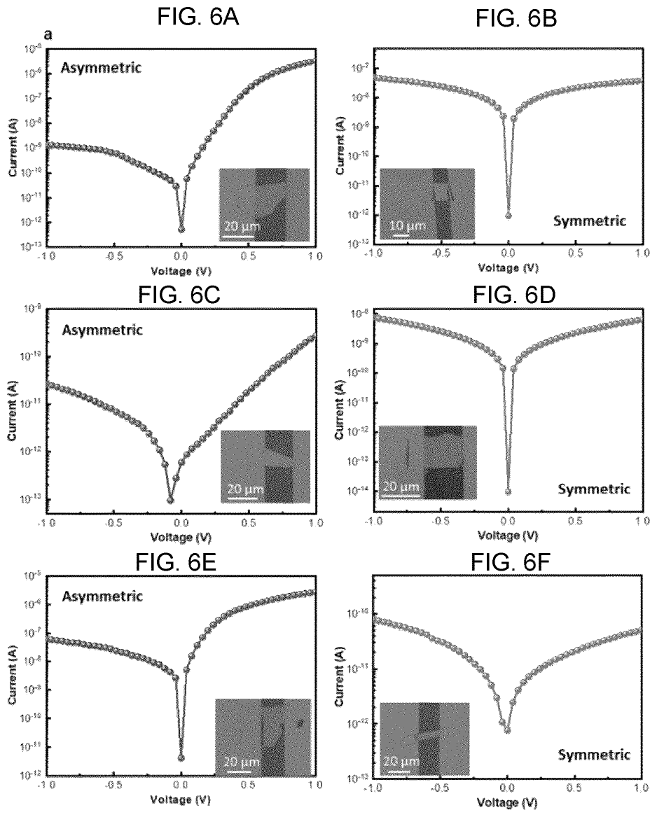

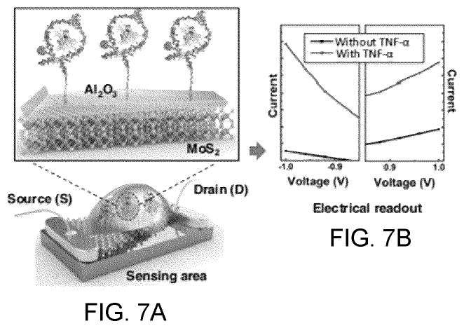

The surface potential across the device area was measured using Kelvin probe force microscopy (KPFM). The surface potential maps were measured on the asymmetric geometry MoS₂ diode across the longer and shorter metal-semiconductor interfaces, shown in FIG. 5A through 5D. The surface potential barrier measured across the longer and shorter MoS₂-metal interfaces, along the line scan shown in FIG. 5A and FIG. 5C, shows a difference in Schottky barrier contact which arises due to different contact area. The appearance of the rectification behavior due to the flake asymmetry is supported by data from asymmetric and symmetric MoS₂ devices fabricated in a similar method as shown in FIG. 6A through FIG. 6F. No significant rectification was observed for symmetric flakes as shown in FIG. 6B, FIG. 6D, and FIG. 6F. The asymmetric barriers at the two MoS₂-metal interfaces of the device depicted in FIG. 7A give rise to diode rectification behavior as shown in FIG. 7B. That is, the absolute value of current is asymmetric between −1 V and +1 V in the initial device, before introducing TNF-α. The exposure of TNF-α to the sensor surface induces a change in rectification behavior in the current-voltage curve, and the relative change in rectification behavior corresponds to the concentration of the TNF-α introduced.

An insulator of Al₂O₃ deposited by atomic layer deposition (ALD) technique performs the following roles: 1) facilitates the aptamer functionalization; and 2) electrically isolates the metal electrodes from the buffer solution containing the cytokine analyte. The thickness of the Al₂O₃ is 5 nm above the MoS₂ crystal, which forms a trench between the metal electrodes, and 75 nm everywhere else, except over the electrodes utilized as contact pads for connection to probes.

The asymmetric geometry diode sensor was functionalized. GOPS coupled to the Al₂O₃ surface in an aqueous solution at a low pH environment. The GOPS was activated by the attachment of a CDI linker followed by coupling between the amine on the 5′ end of the TNF-α-binding aptamer to the GOPS active sites. A DNA aptamer was used as the biomarker receptor since they are label-free, bind specifically to the target analyte, TNF-α, and are potentially reusable. To facilitate the coupling of the aptamer oligonucleotide on the sensing surface, the devices were immersed in a 10 μM aptamer in PBS solution.

### Materials and Chemicals

Bulk 2-H phase single crystal MoS₂ was supplied from SPI Supplies. Glycidoxypropyltrimethoxysilane (GOPS), 1,1′-carbonyldiimidazole (CDI), and acetonitrile (ACN) were purchased from Sigma-Aldrich™. Hydrochloric acid (HCl) was purchased from Fisher Scientific™. Molecular biology grade water/nuclease-free (N-free water) and 1× phosphate-buffered saline (PBS) was purchased from Lonza™. TNF-α-specific aptamer (VR11) with the fluorescent tag (sequence /5AmMC6/TGG ATG GCG CAG TCG GCG ACA A/36-FAM/) was synthesized and purified by Integrated DNA Technologies™. Recombinant Human TNF-α Protein, Recombinant Human C-Reactive Protein, and Recombinant Human IL-6 Protein were purchased from Bio-Techne™.

### Fabrication

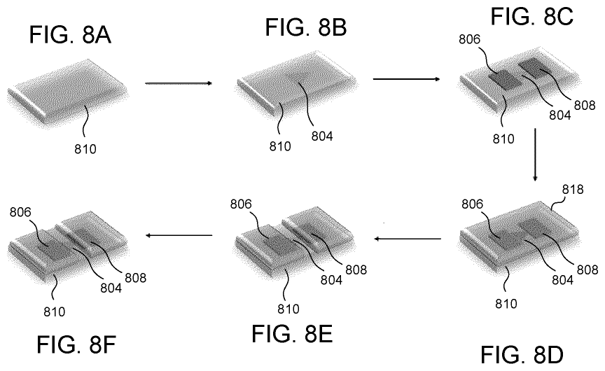

The fabrication steps are illustrated in FIG. 8A through FIG. 8F, where a substrate 810 is illustrated in FIG. 8A. MoS₂ flakes 804 were exfoliated onto a Si/SiO₂ substrate 810 as illustrated in FIG. 8B. Before exfoliation, the Si/SiO₂ substrates were cleaned by sonication in acetone for 10 min, 2-propanol for 10 min and distilled water (DI water) for 10 min. After exfoliation, electrodes 806, 808 were patterned across the flake as shown in FIG. 8C, deliberately introducing an asymmetry in the metal-semiconductor interface, i.e., asymmetry in area and length of the metal-semiconductor interface, using photolithography.

About 10 nm of Cr and about 50 nm of Au were deposited for electrical contacts. The initial gap across the contacts was kept between about 10 μm and about 20 μm.

For passivation, a 70 nm thick Al₂O₃ layer was deposited via atomic layer deposition (ALD) at 250° C. as illustrated in FIG. 8D. A thicker insulator 818 effectively reduced the leakage current between electrodes. A narrow strip was patterned utilizing photolithography with positive photoresist in the middle of the electrode gap over the MoS₂ flake 804 keeping a margin of 2 μm at each side. An Al₂O₃ strip was completely etched in BOE (until the MoS₂ flake was exposed), as shown in FIG. 8E. A second layer of Al₂O₃ of 5 nm thickness was deposited, as shown in FIG. 8F.

To functionalize the sensing area, the pristine diode sensors were submerged in a 10% aqueous solution of GOPS where the pH was maintained at 3.5 using HCL. After degassing for 10 min using N₂, the reaction was allowed to proceed at 90° C. for 4 hours with occasional shaking. The devices were then washed with acetone and 2-propanol and then placed to dry in an oven at 60° C. overnight. The surface was activated by submerging the devices in saturated CDI-acetonitrile solution and shaking for 1.5 h at 20° C. The devices were rinsed with N-free water.

As received amine-modified ssDNA aptamers were reconstituted at a concentration of 100 μM using diluted phosphate buffered saline (PBS) and aliquoted to 50 μl volumes, which were then stored at −20° C. The activated devices were submerged in a 10 μM aptamer solution prepared utilizing the stored samples for 24 h. The unreacted aptamers were then rinsed using N-free water, then dried with N₂ and stored at −20° C. until measurement.

### Testing

As received TNF-α cytokine samples were reconstituted to a concentration of 25 μg/ml and aliquoted to 20 μl volumes which were then stored at −20° C. A similar method was followed in reconstituting and aliquoting IL-6 cytokine. C-reactive protein was reconstituted at a concentration of 6 μg/ml and aliquoted to 500 μl volumes for storing at −20° C. For the tests, different cytokine concentrations ranging from 10 fM to 100 nM, were prepared using the stored samples by diluting in PBS.

### Characterization and Sensing Measurements

Atomic force microscopy (AFM, Asylum MFP3D) was utilized to measure the thickness of the MoS₂ flakes. KPFM (Bruker AFM System) measurements were carried out to map the surface potential difference as shown in FIG. 5A through FIG. 5D. During the KPFM measurements, both sides were grounded. Fluorescent measurements were carried out by employing a fluorescence imaging spectrometer (HORIBA iHR 320) with an excitation laser wavelength at 485 nm. The data was acquired using a 10× objective lens. The acquisition time was set at 10 seconds (s) with 3 accumulations. The range of the spectrum was selected to be from 490 nm to 650 nm with a step size of 2 nm. Electrical measurements were performed using a Keithley™ 4200-SCS semiconductor characterization system connected to a probe station. The Si substrate was placed on an electrically insulating stage in the probe station and was electrically isolated. All IV measurements were conducted in the dark at room temperature in atmospheric pressure with a scan speed of 40 mV/s.

Cytokine in PBS solution was drop cast onto the sensing area at a volume adequate to cover the sensing area of about 2 to about 3 μl and left for 2 minutes to react with the sensor surface after which a current-voltage (IV) response measurement was taken over an applied voltage of −1 V to 1 V. The cytokine in PBS solution drop was removed using an air blower and the next cytokine concentration in PBS solution was immediately dropped onto the sensing area.

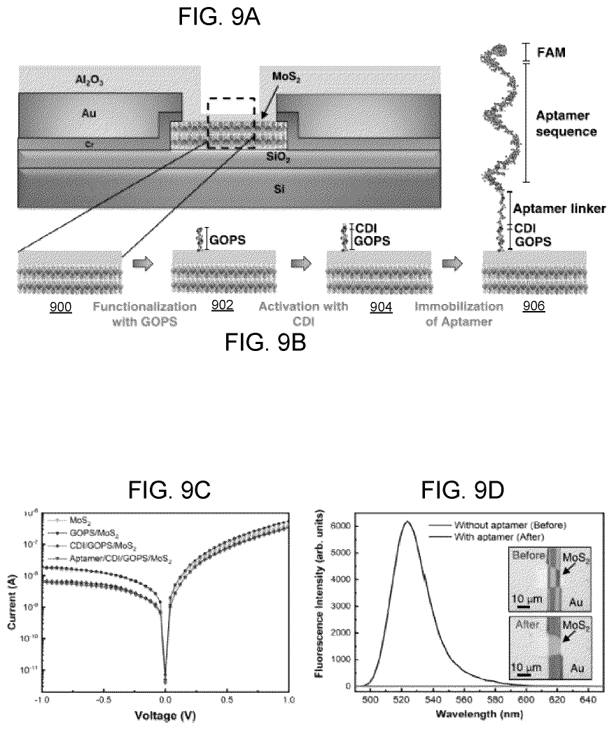

The IV characteristics from a device at different steps of the functionalization process illustrated in FIG. 9A and FIG. 9B are shown in FIG. 9C. The device (coated with Al₂O₃) shown in FIG. 9A and labelled 900 in FIG. 9B initially displayed a rectification factor (RF) (log|I_{-1V}|−log|I_{+1V|) of about ~}1.4. After the GOPS functionalization at 902, the rectification factor increased slightly to about ~1.5 and after the CDI functionalization step at 904, the rectification factor further increased to about ~1.7. The rectification was almost unaffected during the aptamer coupling to the activated GOPS step at 906. The first step of the functionalization involved the hydroxyl groups at the Al₂O₃ surface reacting with the GOPS in which the epoxide ring on the GOPS opened to produce a diol. These diols were activated by CDI to create more amine-targeted binding sites. These surface modifications induced a change in the surface potential which caused the changes in the rectification observed in FIG. 9C. However, during the final step, the amine-modified aptamers in a PBS solution coupled only to the CDI moieties and did not induce a strong change in the overall rectification of the device.

Because the aptamer oligonucleotides utilized contained a fluorescent dye (FAM) on the 3′ end, fluorescence spectroscopy was used to verify that the aptamers had successfully coupled to the sensor surface. FIG. 9D shows fluorescence spectrum measurement obtained with and without aptamer functionalization. The emission spectrum of the FAM (peak emission at 525 nm) was absent in the bare sample. The inset of FIG. 9D shows optical images before and after sensor functionalization.

### Electrical Measurements for Sensing TNF-α

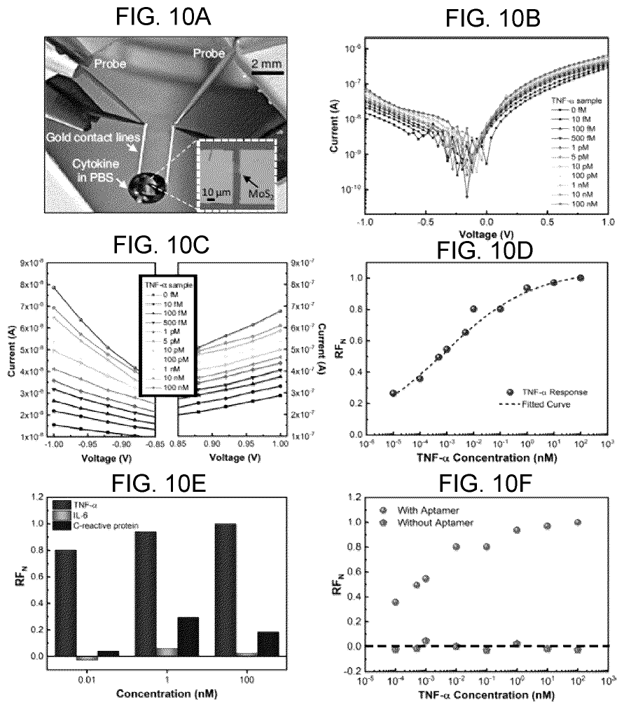

An optical image of an asymmetric geometry diode sensor contacted by two probe tips is shown in FIG. 10A. The Al₂O₃ dielectric layer was removed at the end of the gold contact lines, over the electrodes (also referred to as contacts or contact pads) to facilitate an ohmic electrical connection between the probes and pads. Because the rectification of the MoS₂ Schottky diodes are sensitive to light, all the measurements were carried out in the dark.

The IV response obtained for a single device as a function of cytokine concentration is shown in FIG. 10B (log scale). As the concentration of the cytokine was increased, an increase in RF was observed. A magnified view of the IV curves at high voltages (linear scale) is shown in FIG. 10C.

Due to variations from device-to-device in MoS₂ flake geometries and thicknesses, and in the aptamer functionalization process (fluctuations in room temperature and humidity), a normalized rectification factor, RF_{N}, was used to compare different devices, defined as:

$${RF}_{N} = \frac{RF - {RF}_{PBS}}{{RF}_{max} - {RF}_{PBS}} ,$$

where RF_{PBS} is the RF with only PBS (0 fM TNF-α in FIG. 10B and FIG. 10C) and RFₘₐₓ is the maximum RF for each individual device, which may be at the maximum concentration. The RF_{N} as a function of TNF-α cytokine concentration (presented as x-axis data), is shown FIG. 10D. The data was fit with a classical Hill function:

$${RF}_{N} = \frac{1.05}{1 + 1 {0}^{( - 3.08 - x ) 0.26}}$$

where 1.05=top asymptote (A1)−bottom asymptote (A2), −3.08=log of center of x-axis data (log x0), and 0.26=hill slope (p). A reduced χ² statistic of 0.0003 was obtained for the fitted curve.

Sensor specificity was achieved by employing an aptamer DNA sequence, referred to as VR11, which has high specificity to TNF-α cytokine. The specificity of the sensor was tested by introducing two non-target inflammatory biomarker proteins, IL-6 and C-reactive protein, to the sensor under the same conditions as TNF-α. The RF_{N} for three different non-target protein concentrations (0.01, 1, 100 nM) alongside TNF-α is shown in FIG. 10E.

For the non-specific IL-6 cytokine, the RF_{N} response was close to zero at all three concentrations. On the other hand, the non-target C-reactive protein showed a small RF_{N} response at 0.01 nM and a noticeably higher response at higher concentrations (1 nM and 100 nM). Still, the highest response observed for C-reactive protein was 3 times lower than the TNF-α cytokine response at the same concentration.

Without being bound by theory, a possible cause for the lower specificity seen in the C-reactive protein case may be the higher molecular weight of the C-reactive protein, which may cause a considerable number of proteins to physically adsorb to the sensing area without being bound to the aptamer. The sensor may be improved by surface passivation such as ethanolamine, after the aptamer functionalization to block non-specific binding at unreacted sites on the sensing area.

To further verify that the response observed in the sensor is due to the successful binding of the TNF-α cytokine to the aptamer, a negative control test was carried out on another asymmetric geometry diode sensor prepared using the same fabrication process and functionalized using GOPS and CDI linkers but without aptamers. The RF_{N} response of the control device without aptamer functionalization and the sensor that was fully functionalized with aptamer, for different TNF-α concentrations, is shown in FIG. 10F. A stark contrast can be observed wherein the RF_{N} of the aptamer-functionalized sensors changed as a function of TNF-α concentration while the control device response fluctuated around the zero level.

### Detection Mechanism

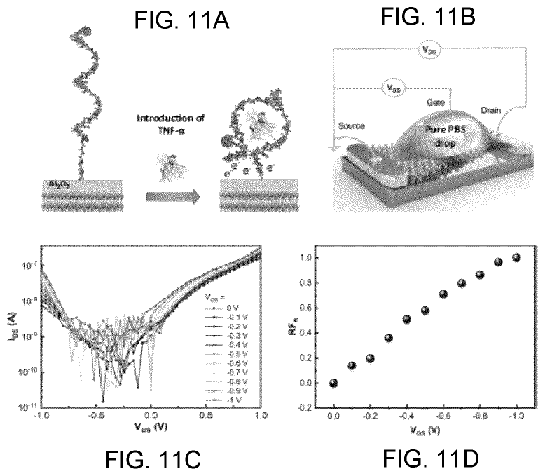

TNF-α molecules, diluted in PBS buffer solution (1×) (pH ~7.4), are deemed to be negatively charged. When a cytokine binds to a TNF-α specific aptamer, the aptamer folds, forming a stable and compact G-quadruplex, which causes the negatively charged cytokine, along with the electron-rich aptamer end to come closer to the Al₂O₃ surface as illustrated in FIG. 11A. As a result, there is an increase in negative charge on the Al₂O₃ surface inducing a negative gating effect on the MoS₂ sensing layer, the likely cause of the change in the rectification factor of the sensor.

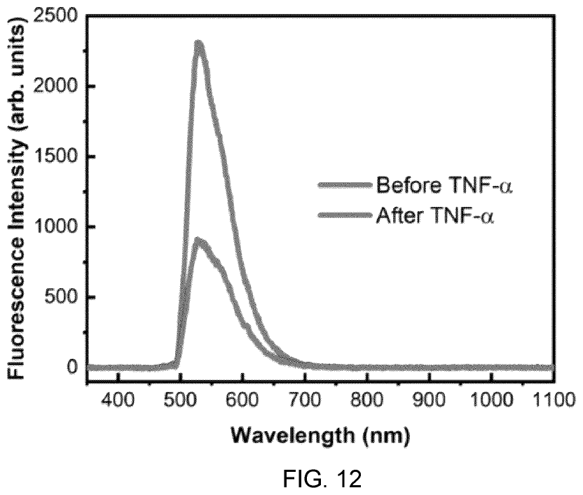

Since the aptamer changes its form upon binding to a target, the fluorescence intensity changes depend on the manner of the FAM dye modification. In this case, the fluorescence intensity is expected to decrease after the cytokine interaction due to the aptamer folding. Hence, the decrease in the fluorescence intensity is regarded as an indicator of the change in the aptamer structure into a compact form, bringing the charged cytokine closer to the surface, as shown in FIG. 12.

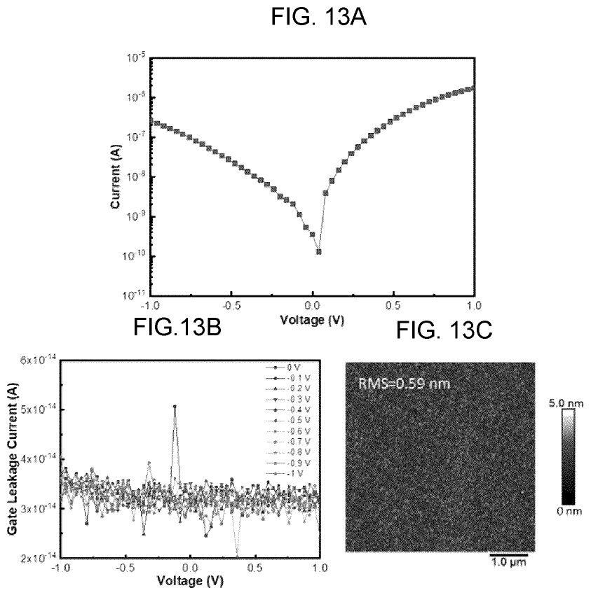

A liquid gating measurement, illustrated in FIG. 11B, was performed to support the proposed detection mechanism. FIG. 11C shows the IV response between the drain and source (I_{DS}) Au electrodes (also referred to as contacts), obtained for a diode sensor under increasing negative liquid gate voltage (V_{GS}) from 0 V to −1 V, applied via a droplet of PBS solution to the sensing area. The I-V response shows a noticeable fluctuation in current between −0.75 V and 0 V which is believed to be due to the presence of PBS because the I-V response in air did not display such behavior as shown in FIG. 13A. Graphene-based FET biosensors are susceptible to disturbance occurring in the capacitance across the electrical double layer formed at the solution-graphene interface. With the thin dielectric layer over the sensing area (5 nm), The diode sensors may undergo a similar disturbance during the liquid-gating which causes the current to fluctuate at low voltage values. Gate leakage current for each I-V response shown in FIG. 10C was shown to be negligible as shown in FIG. 13B and an AFM height image over the 5 nm Al₂O₃ film in the sensing area, showing the oxide layer is continuous and free of pinholes, is shown in FIG. 13C.

The RF_{N} increases with increasing negative V_{G}s as illustrated in FIG. 11D, which is similar to the response seen in sensor output during the interaction between TNF-α to the aptamer measured in FIG. 10B, FIG. 10C, and FIG. 10D. The binding of TNF-α to the aptamer prompts a gating effect on the MoS₂ sensing layer, which induces the change in the diode rectification.

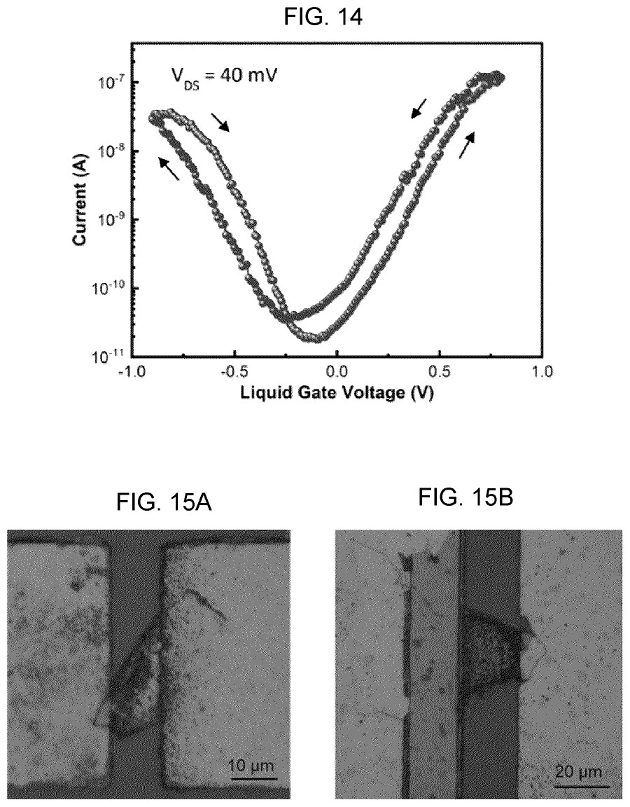

Another noticeable observation in the IV response is the increase in the current level as a function of both increasing TNF-α concentration as shown in FIG. 10B and increasing negative gate voltage (see FIG. 11C). Conventionally, a negative gate voltage prompts a decrease in drain-source current in FET transistors using n-type materials, such as MoS₂ crystals grown by chemical vapor deposition. Defects such as S vacancies are likely to be in abundance in such material, enhancing n-type behavior. However, in mechanically exfoliated thin MoS₂ flakes, which have less S deficiency, an enhanced p-channel with more balanced ambipolar transport may be realized. Ambipolar operation in MoS₂ has been previously demonstrated by the observation of an increase in hole current with increase in negative liquid gate voltage. Similarly, the increase in the current level with the cytokine concentrations/negative liquid gate voltage measured in cytokine diode sensor shows the existence of ambipolar transport in the thin MoS₂ flakes, which was confirmed by the transfer curve shown in FIG. 14.

### DISCUSSION

Electrochemical biosensors based on detecting biological analyte through redox reactions on electrodes have previously been shown to achieve LODs in the fM range. However, compared to electrical sensors such as FET based biosensors, the specificity of the electrochemical biosensors is lower. The FET biosensors have displayed an enhanced specificity in detecting a targeted cytokine. Even so, typical FET cytokine sensors that have employed graphene as the sensing material, have reported a relatively high LOD, in the pM range. The lack of a bandgap in graphene fundamentally limits its sensitivity and reduces the dynamic range of the biosensor. It has been shown that FETs using 2D MoS₂ as the channel material can be 70 times more sensitive than graphene FETs in biosensing applications. MoS₂ FET-based biosensors used in the detection of various cytokine including TNF-α biomarkers have been reported with LODs in the range of 60-400 fM.

Utilizing the device for detecting biomarker concentration described with reference to FIG. 1, rapid detection of biomarkers, such as TNF-α, with a LOD of 10 fM is possible. The relatively low LOD was achieved due to the device structure. In one example, the thin insulator, for example 5 nm, over the sensing MoS₂ area, combined with a thicker insulator, for example, 75 nm, over the electrode areas which reduced leakage currents provided low LOD as referred to above.

Because the aptamers utilized in examples herein are smaller in size, for example, compared to antibodies, the aptamers provide improved transportation of the target towards the sensor's surface by comparison to antibodies. The aptamer sequence disclosed above, VR11, brings the charged TNF-α closer to the sensor surface upon affinity binding.

A single thin insulator to cover the sensing area of the semiconductor material 104 as well as the electrodes led to device degradation during measurement due to possible oxidation of the MoS₂ flakes (See FIG. 15A and FIG. 15B). In the examples referred to herein, passivation was carried out in a two-step process in which a thicker Al₂O₃ layer was used to passivate the gold electrodes and a thinner layer covered the sensing area to passivate the sensing material, MoS₂, and facilitate the aptamer functionalization. Other insulators may be utilized and other processes may be employed such that the insulator is thicker on the electrodes 106, 108 than on the semiconductor material 104.

The performance of the sensor is also affected by rectification factor of the asymmetric diode before functionalization, which is generally higher for materials such as flakes with a triangular shape. Mechanically exfoliated flakes were utilized to demonstrate the biomolecule detection method.

For commercial applications, lithographic control over the material geometry may be utilized to make reproducible and reliable sensors for clinical usage with up-scalable potential. By employing a large-area compatible process to prepare thin semiconductor films, the sensing area is patternable in to, for example, regular triangular shapes, using lithography and etching to have better control over the geometry. With the advancement of large area 2D material synthesis, scale-up of diode sensors is possible.

Detection of biomarkers, such as TNF-α, is possible at concentrations as low as 10 fM combined with a wide dynamic range of detection between 10 fM to 1 nM, utilizing an asymmetric geometry diode sensor. The sensor may be utilized for rapid detection of femtomolar concentrations of biomarker utilizing a simple two electrode design, making the device suitable for easy-to-use and rapid point-of-care testing.

In the present device or sensor, the asymmetrical semiconductor material is coated with a thin insulating layer, which is then functionalized with a bioreceptor that specifically binds to the targeted biomarker. In the example of a sample containing TNF-α (e.g., blood serum), the sample is drop cast onto the sensor, the TNF-α cytokines bind to the aptamer forming a G-quadruplex structure that leads to negatively charged TNF-α moving closer to the sensor surface. Changes in surface charge density induces a change in the electrical rectification behavior in the asymmetric geometry MoS₂ diode.

Due to the simple operation, and absence of complicated post-measurement analysis, the use of the device requires very little training and is therefore suitable for point-of-care diagnostic applications. Because the detection of the biomarker inherently depends upon the bioreceptor anchored to the sensing area, the sensor device can be extended to detect other biomarkers and is not limited to cytokines. Proteins or other biomarkers molecules may be detected utilizing a suitable bioreceptor that specifically binds to the corresponding biomarker.

Thus, a device for detecting biomarker concentration uses an asymmetric geometry diode to detect very low concentrations of biomarkers. The binding of biomarkers to the bioreceptor changes the surface energy and the rectification behavior of the diode, which can be measured by applying a voltage and recording the current. The rectification factor, defined as the ratio of current at −1V and +1V, decreases as the biomarker concentration increases, facilitating a quantitative detection of the biomarker. The invention offers advantages over existing detection methods, such as high sensitivity, wide dynamic range, rapid measurement, low sample volume, simple fabrication, and easy readout. The invention has potential applications for point-of-care diagnostics of diseases, such as cancer, tuberculosis, and COVID-19.

The scope of the claims should not be limited by the preferred embodiments set forth in the examples, but should be given the broadest interpretation consistent with the description as a whole.

What is claimed is:

1. A device for detecting a biomarker concentration, comprising:
a diode comprising a semiconductor having an asymmetric geometry, the diode including a first electrode and a second electrode contacting the semiconductor on a substrate; and
a functionalization layer over the surface of the semiconductor, the functionalization layer comprising biomarker specific bioreceptors.

2. The device according to claim 1, wherein the first electrode and the second electrode have asymmetry in metal-semiconductor contact area between the two contacts to facilitate diode rectification behaviour.

3. The device according to claim 1, wherein the diode includes an insulator on at least a portion thereof.

4. The device according to claim 1, comprising a first connector coupled to the first electrode and a second connector coupled to the second electrode, the first connector and the second connector for electrical connection to the first electrode and the second electrode.

5. The device according to claim 1, comprising a measurement circuit connected to the first electrode and the second electrode, and configured to measure a rectification change of the diode caused by binding of the biomarker to the bioreceptors.

6. The device according to claim 1, wherein the semiconductor comprises a MoS₂ crystal or silicon.

7. The device according to claim 1, wherein the bioreceptor comprises an aptamer or antibody.

8. The device of claim 1, wherein the functionalization layer comprises a linker molecule coupling the bioreceptor to the surface of the semiconductor.

9. A method of fabricating a biosensor for detecting biomarkers, comprising:
disposing a semiconductor material onto a substrate;
depositing metal contacts on the semiconductor material, the metal contacts having an asymmetric interface geometry with of the semiconductor material;
depositing an insulator over the semiconductor material and the metal contacts;
functionalizing the insulator utilizing target biomarker specific bioreceptors.

10. The method according to claim 9, wherein depositing the insulator comprises:
depositing a first insulator layer to cover the metal contacts,
removing the first insulator layer over the semiconductor materials by patterning the first insulator layer; and
depositing a second insulator layer to facilitate the functionalization over the semiconductor material.

11. The method according to claim 9, wherein functionalizing comprises adding linker molecules prior to treating with bioreceptors, the linker molecules coupling the bioreceptors to the insulator on the surface of the semiconductor.

12. The method according to claim 9, wherein functionalizing comprises treating with a coupling agent, activating the coupling agent, and immobilizing the biomarker specific bioreceptors on the coupling agent.

13. The method according to claim 12, wherein treating with a coupling agent comprises treating with a silane coupling agent, activating the coupling agent comprises activating with carbodiimide, and immobilizing comprises immobilizing target cytokine specific aptamers on the coupling agent.

14. The method according to claim 9, wherein disposing the semiconductor material on the substrate comprises exfoliating a semiconductor layer onto a Si/SiO₂ substrate.

15. The method according to claim 9, wherein depositing the metal contacts comprises depositing by photolithography and thin film deposition.

16. The method according to claim 9, wherein depositing the insulator comprises depositing by atomic layer deposition.

17. The method according to claim 9, wherein depositing the insulator comprises depositing such that the insulator has a first thickness on the metal contacts and a second thickness on the semiconductor material, and wherein the first thickness is greater than the second thickness.

18. The method of claim 17, wherein depositing the insulator comprises depositing such that the first thickness of the first insulator is greater than about 50 nm and the second thickness of the insulator is greater than about 3 nm.

19. The method of claim 10, wherein depositing the second insulator layer comprises depositing such that the second insulator layer is about 5 nm thick.

20. Use of a sensor for detecting a biomarker concentration, the sensor including a diode comprising a semiconductor material having an asymmetric geometry, the diode including a first electrode and a second electrode contacting the semiconductor material on a substrate, and a functionalization layer on the surface of the semiconductor, the functionalization layer comprising biomarker specific bioreceptors,
wherein the sensor is configured to be exposed to a sample,
wherein the sensor is configured to be coupled to a measurement device to measure the current-voltage response of the sensor to determine a change in rectification factor,
and wherein the change in rectification factor is correlatable to the biomarker concentration in the sample.
